(19) United States
(12) Patent Application Publication
(10) Pub. No.: US 2012/0239683 A1
(43) Pub. Date: Sep. 20, 2012

(54) Food Related Social Networking Website

(75) Inventor: Jason E. Starkman, Bay Harbor Islands, FL (US)

(73) Assignee: FOODSIES.COM, LLC, Bay Harbor Islands, FL (US)

(21) Appl. No.: 13/402,858

(22) Filed: Feb. 22, 2012

Related U.S. Application Data
(60) Provisional application No. 61/445,326, filed on Feb. 22, 2011.
(60) Provisional application No. 61/537,359, filed on Sep. 21, 2011.

(51) Int. Cl. G06F 17/30

(52) U.S. Cl. 707/769; 707/E17.014

(57) ABSTRACT

A food-related website utilizes a method to recommend to a user food-related results based on a criteria entered by the user. The method can match criteria in food-related results to make suggestions to the user. The method can match criteria in other user's accounts to recommend food-related results that match the criterion and that the other user recommends. Food-related result can be a food, ingredient, recipe, meal, restaurant, drink, or the like.

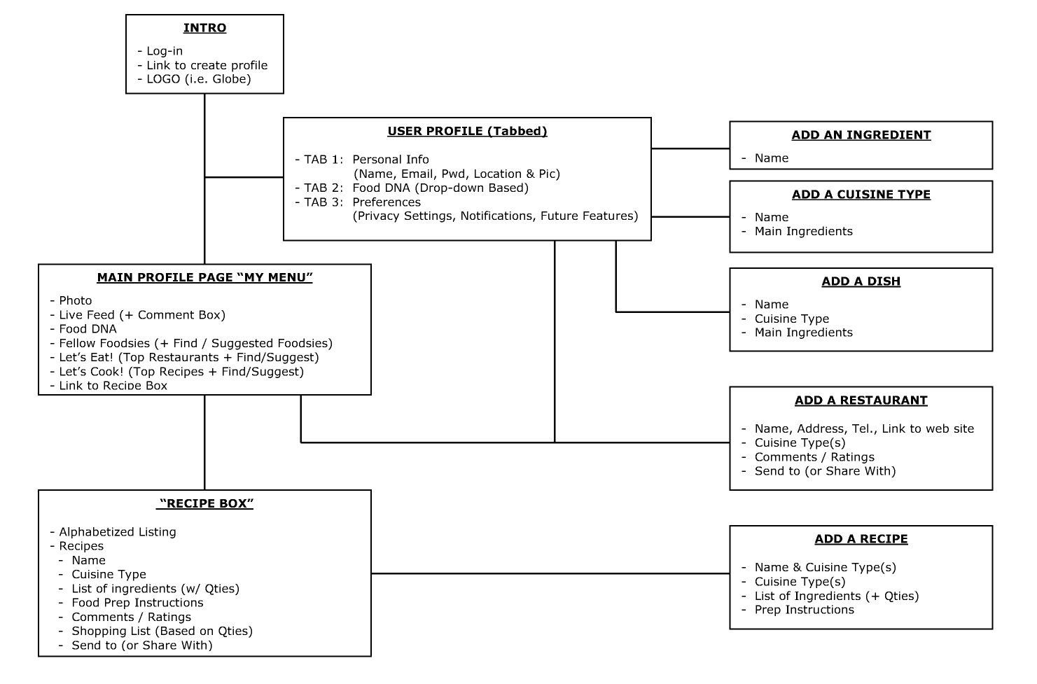

### CROSS-REFERENCE TO RELATED APPLICATIONS

This application claims the benefit of U.S. Provisional Application No. 61/445,326, filed Feb. 22, 2011, and U.S. Provisional Application No. 61/537,359, filed Sep. 21, 2011, both of which are incorporated by reference.

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to social networks relating to food, restaurants, and dining.

2. Description of the Related Art

The term Web 2.0 is associated with web applications that facilitate interactive systemic biases, interoperability, user-centered design, and developing the World Wide Web. A Web 2.0 site allows users to interact and collaborate with each other in a social media dialogue as consumers of user-generated content in a virtual community, in contrast to websites where users are limited to the active viewing of content that they created and controlled. Examples of Web 2.0 include social networking sites, blogs, wikis, video sharing sites, hosted services, web applications, and mashups.

A web 2.0 website involving restaurant reviews is available online at WWW.YELP.COM. Yelp provides a local search. Yelp provides online local search capabilities for its visitors. A typical search includes what the user is seeking (e.g. a barber shop) and the location from which the search is to be performed, entered as a specific address, neighborhood, city/state combination, or zip code. Each business listing result contains a 5-point rating, reviews from other site visitors, and details such as the business address, hours, accessibility, and parking. Site visitors can aid in keeping the business listings up to date, with moderator approval, and business owners can directly update their own business' listing information. Listings and related content are organized by city and a multi-tier categorization system. Content and listings can also be discovered through categorized reviews or via Yelp member profiles and their review lists. Yelp provides reviews based on search criteria entered by the user. Yelp does not predict search results based on a user's profile.

### BRIEF SUMMARY OF THE INVENTION

The invention encompasses a method for suggesting food, meals, restaurants, and the like based on criteria entered by the user in the user's profile. The recommendations are based on results that match the criteria. The recommendations can be based on recommendations made by other users with similar criteria.

An object of the invention is to provide a food-related website that suggests food, meals, drinks, restaurants, and the like based on criteria entered by the user. The website will provide results by matching goods and services that match the criteria. The website will also create suggestions based on recommendations from other users with similar criteria. The users can enter ratings and comments, which further affect results.

A social networking website allows users to create their own “Foodsie” profile based on all aspects of the foods, meals, groceries, beverages, etc. that they consume as well as the places, restaurants, markets, and bars in which they consume/buy them.

Once a user establishes a profile, the user may chose with whom to share their profile by inviting people to view the user's profile. In addition, the user can unlock his or her profile so that it may be shared with other profiles.

The other key ingredient is that the users share their review, experiences, and opinions on all of the foods, restaurants, meals, markets, bars, beverages, groceries, etc. By uploading them as frequently as they want, the website will share with the use the “world's” (i.e. other users') reviews of anything in their profile at the click of a button, without having to search for a specific cuisine, meal, etc, because it is already in their profile and the website will automatically match the reviews from others as they are uploaded.

Other features of the invention are set forth in the appended claims.

Although the invention is illustrated and described herein as embodied in a food-related website, the invention is not limited to the details shown because various modifications and structural changes may be made without departing from the invention and the equivalents of the claims. However, the construction and method of operation of the invention together with additional objects and advantages thereof will be best understood from the following description of specific embodiments when read in connection with the accompanying drawings.

### BRIEF DESCRIPTION OF THE SEVERAL VIEWS OF THE DRAWING

The sole FIGURE is a schematic sitemap of a website according to the invention.

### DETAILED DESCRIPTION OF THE INVENTION

Embodiments of the invention are described below and are shown in the sole FIGURE of the drawing.

The sole FIGURE shows a sitemap of a website, which is an embodiment of the invention. The sitemap shows the menu hierarchy of the website. The sitemap shows how information will be collected from users.

In a preferred embodiment, Foodsies.com will be a social network for food lovers. The social network is to be accessible via the World Wide Web. Another embodiment is a software application on a smartphone such as those sold under the trademark IPHONE® App.

Users define their “Food DNA”. The Food DNA links them to other users sharing similar Food DNA.

The following are a set of features of the site will include the ability to communicate with other “Fellow Foodsies” via a live feed. In addition, users can search for and be recommended to restaurants based on the user's Food DNA. The site will include the ability for the user to post recipes to their “Recipe Box”. The website records users' rating and comments on both restaurants and others' recipes. Another primary feature of the site will include the ability of the user to filter the above-mentioned information based on location, as well as the level of Fellow Foodsies desired (i.e., My Fellows, Locals, and The World).

In a preferred embodiment, the site includes “Pro Accounts”, marketing distribution lists, and hyperlinks to markets, equipment manufacturers, and vendors.

In a preferred embodiment, the website will also include an e-commerce section where visitors will be able to purchase merchandise related to the website and to food, dining, and cooking.

A preferred embodiment of the website includes the following pages.

Intro Page

The intro page is the main page or homepage that is visited when entering the website (e.g. www.Foodsies.com). From the intro page, first-time users register. Existing users log in.

User Profile Page

The user profile page stores information about a user. In particular, the profile pages stores information about food preferences, restaurant preferences, and ingredient preferences. The profile page includes geographic information as well biographical information. The user profile page can include “tabs” to organize the information.

Personal Information. The user inputs a picture and basic personal information such as name, e-mail, user name, password, and location.

Food DNA Tab. The user inputs the user's top fives: top five dishes, top five ingredients, top five cuisines, and top five restaurants. The top fives form the user's Food DNA, which will be the base for collecting information that the user will see on his website. The user inputs food allergies and dislikes. The allergies and dislikes cause an alert to activate if the user retrieves a recipe that contains the food. The user inputs his or her diet. Diet information may be used to populate a focus group to be sent as reference to purchaser (i.e. nutritionist).

Preferences Tab. A user can adjust privacy/alerts and other settings to control the website activity.

Nickname. A user can set-up a food-friendly nickname to display on the Menu page.

My Menu! (Main Profile Page)

The Menu page is the main profile page for each user. The user's Food DNA and location control the default content that shows on the Menu.

Fellow Foodsies. The page provides a list of other users (i.e. Foodsies) that the user has in their network. Fellow Foodsies includes Foodsies that the user added, local Foodsies with similar Food DNA, and Global Foodsies with similar Food DNA.

Live Feed. The live feed displays live updates from fellow Foodsies, restaurants, and recipes that are added or rated.

Let's Eat. The Let's Eat feed shows the top-rated restaurants serving cuisine that is in the user's Food DNA for a given location. The user can add a restaurant that's not in the list. The user can search for a restaurant. The user can select a restaurant from the list. In a selected restaurant, the user will see name, address, phone number of the restaurant. The user will see others' ratings & comments. The user can add a rating and comments.

Let's Cook. The Let's Cook feed lists other users' recipes of cuisines that match the user's Food DNA. The user can access their recipe box. The user can search for a recipe. The user can select a recipe from the list. In a selected recipe, the user will see name, cuisine type, ingredients, and prep instructions. The user can generate a shopping list (quantities will change based on number of servings desired). The user can share the recipes with Fellow Foodsies or via e-mail (which can include invitation to join the website).

Unless otherwise mentioned the reference numbers are used consistently throughout the figures.

What is claimed is:

1. A method of suggesting food-related information to a user, which comprises:
entering a food-related criterion about an ingredient, a cuisine, a recipe, or a restaurant;
suggesting a food-related result based on the user-entered food-related criterion.

2. The method according to claim 1, wherein the food-related result is one of an ingredient, a cuisine, a recipe, or a restaurant.

3. The method according to claim 1, wherein the food-related result is based on a criterion entered by a provider.

4. The method according to claim 1, wherein the food-related result is derived from a matching criterion of another user.
